(19) United States
(12) Patent Application Publication
(10) Pub. No.: US 2015/0030260 A1
(43) Pub. Date: Jan. 29, 2015

(54) ANALYSIS SYSTEM

(71) Applicant: NEC Corporation, Minato-ku, Tokyo (JP)

(72) Inventors: Takeshi Arikuma, Tokyo (JP); Kazuya Koyama, Tokyo (JP); HIROSHI Yamada, Tokyo (JP); YOICHI Nagai, Tokyo (JP)

(73) Assignee: NEC CORPORATION, Minato-ku, Tokyo (JP)

(21) Appl. No.: 14/379,541

(22) PCT Filed: Feb. 14, 2013
(86) PCT No.: PCT/JP2013/000796

§ 371 Date: Aug. 19, 2014

(30) Foreign Application Priority Data
Mar. 2, 2012 (JP) 2012-046674

(51) Int. Cl. G06K 9/62

(52) U.S. Cl. CPC G06K 9/6262
USPC 382/309

(57) ABSTRACT

An analysis system of the present invention includes: an analysis process executing means for controlling operation of the analysis system configured by a plurality of analysis engines to execute an analysis process; and an input quality regulating means for determining quality characteristics of processing target data inputted into the respective analysis engines so as to satisfy a preset requirement for accuracy of an analysis result, and regulating the quality characteristic of the processing target data inputted into a given analysis engine configuring the analysis system based on the determined quality characteristics.

### TECHNICAL FIELD

The present invention relates to an analysis system. More specifically, the present invention relates to an analysis system configured by a plurality of analysis engines combined with each other.

### BACKGROUND ART

In recent years, analysis engines that analyze various data have been developed in accordance with development of information processing techniques. Various analysis engines have been developed: for example, an analysis engine that generates position information tracing the flow of a person from moving image data, an analysis engine that identifies a person from still image data, and an analysis engine that generates text data from speech data.

Also, an analysis system configured by the same type or different types of analysis engines combined with each other and capable of producing various analysis results from input data has been developed. It can be applied to, for example, a system that executes analysis processes such as processing video data inputted from a camera by using a person extraction engine, a flow extraction engine, a face extraction engine, a face verification engine and so on in parallel or in series and thereby determining a person of a specific behavior. In such an analysis system configured by many analysis engines, it is desirable that the accuracy of an analysis result is guaranteed at a given level or more, and it is desirable that a processing time is short, for example, an analysis result is outputted in real time.
Patent Document 1: Japanese Unexamined Patent Application Publication No. 11-136499 (1999)

On the other hand, because analysis engines configuring an analysis system have different characteristics, respectively, there is a problem that it is difficult to design an analysis system so that a final analysis result satisfies requirements such as accuracy and a processing time. For example, a system designer needs to design a system with the understanding of the characteristics of the respective engines, but such a work consumes time and makes it difficult to newly design an analysis system.

Patent Document 1 discloses an image processing system in which an image provision device and an image processing device are connected. This image processing system executes a process that the image provision device and the image processing device exchange information such as resolution with each other and the image provision device transfers an image at required resolution to the image processing device. This technique is effective for transmitting and receiving processing target data between devices on a one-to-one basis, but it is difficult to apply this technique to a system in which a plurality of devices process processing target data. Therefore, there is still a problem that, when designing an analysis system configured by a plurality of analysis engines, it is difficult to design the system so as to satisfy proper analysis requirements.

### SUMMARY

Accordingly, an object of the present invention is to solve the abovementioned problem that it is difficult to design an analysis system configured by a plurality of analysis engines.

An analysis system as an aspect of the present invention includes:

an analysis process executing means for controlling operation of the analysis system to execute an analysis process, the analysis system configured by a plurality of analysis engines executing predetermined analysis processes, respectively; and

an input quality regulating means for determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics.

The analysis process executing means is configured to control the operation of the analysis system so as to input the processing target data of quality corresponding to the quality characteristic regulated by the input quality regulating means into the given analysis engine.

Further, a computer program as another aspect of the present invention is a computer program including instructions for causing an information processing device, which controls operation of an analysis system configured by combining a plurality of analysis engines executing predetermined analysis processes, respectively, to execute an analysis process, to realize:

an input quality regulating means for determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics; and

an analysis process executing means for inputting the processing target data of quality corresponding to the quality characteristic regulated by the input quality regulating means into the given analysis engine, and controlling the operation of the analysis system to execute an analysis process.

Further, an analysis method as another aspect of the present invention is an analysis method for controlling operation of an analysis system configured by combining a plurality of analysis engines executing predetermined analysis processes, respectively, to execute an analysis process. The analysis method includes:

determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics; and

inputting the processing target data of quality corresponding to the regulated quality characteristic into the given analysis engine, and controlling the operation of the analysis system to execute an analysis process.

With the configurations as described above, the present invention facilitates design of an analysis system configured by a plurality of analysis engines.

### BRIEF DESCRIPTION OF DRAWINGS

FIG. 1 is a block diagram showing the configuration of an analysis system according to a first exemplary embodiment of the present invention;

FIG. 2 is a diagram showing an example of data stored in a process flow storing part of an analysis device disclosed in FIG. 1;

FIG. 3 is a diagram showing an example of data stored in the process flow storing part of the analysis device disclosed in FIG. 1;

FIG. 4 is a diagram showing an example of data stored in a characteristics information storing part of the analysis device disclosed in FIG. 1;

FIG. 5 is a diagram showing an example of data stored in the characteristics information storing part of the analysis device disclosed in FIG. 1;

FIG. 6 is a flowchart showing the operation of the analysis device disclosed in FIG. 1;

FIG. 7 is a diagram showing how the analysis device disclosed in FIG. 1 processes;

FIG. 8 is a diagram showing how the analysis device disclosed in FIG. 1 processes;

FIG. 9 is a diagram showing how the analysis device disclosed in FIG. 1 processes;

FIG. 10 is a diagram showing how the analysis device disclosed in FIG. 1 processes;

FIG. 11 is a block diagram showing the configuration of an analysis system according to a second exemplary embodiment of the present invention; and

FIG. 12 is a block diagram showing the configuration of an analysis system according to Supplementary Note 1 of the present invention.

### EXEMPLARY EMBODIMENTS

### First Exemplary Embodiment

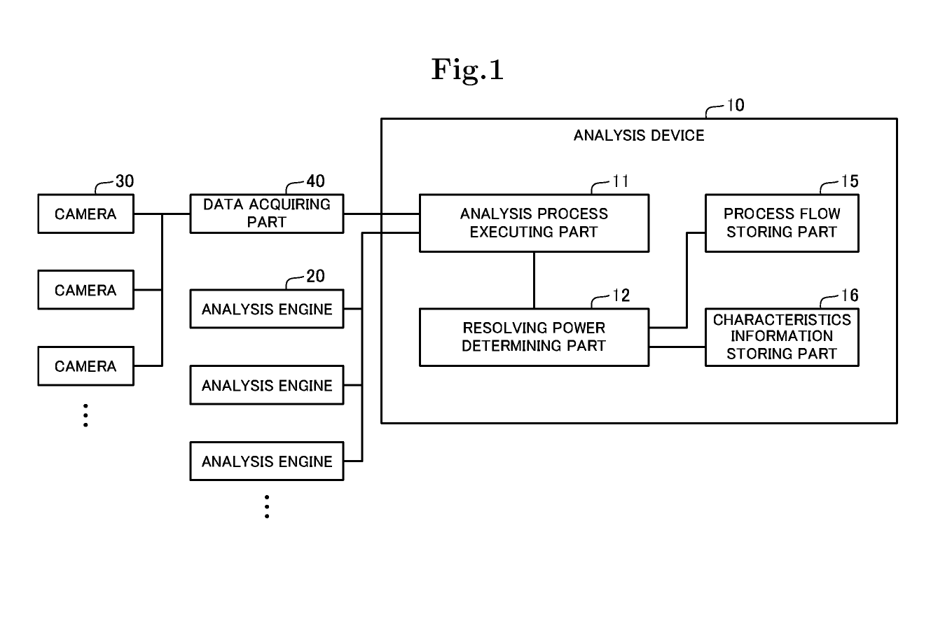

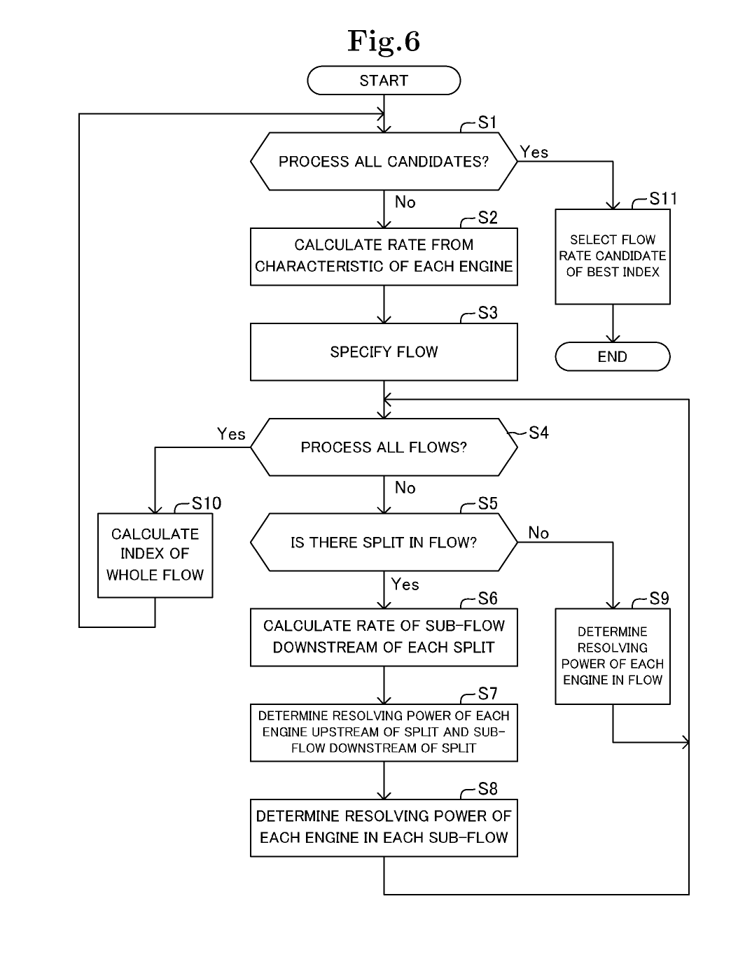

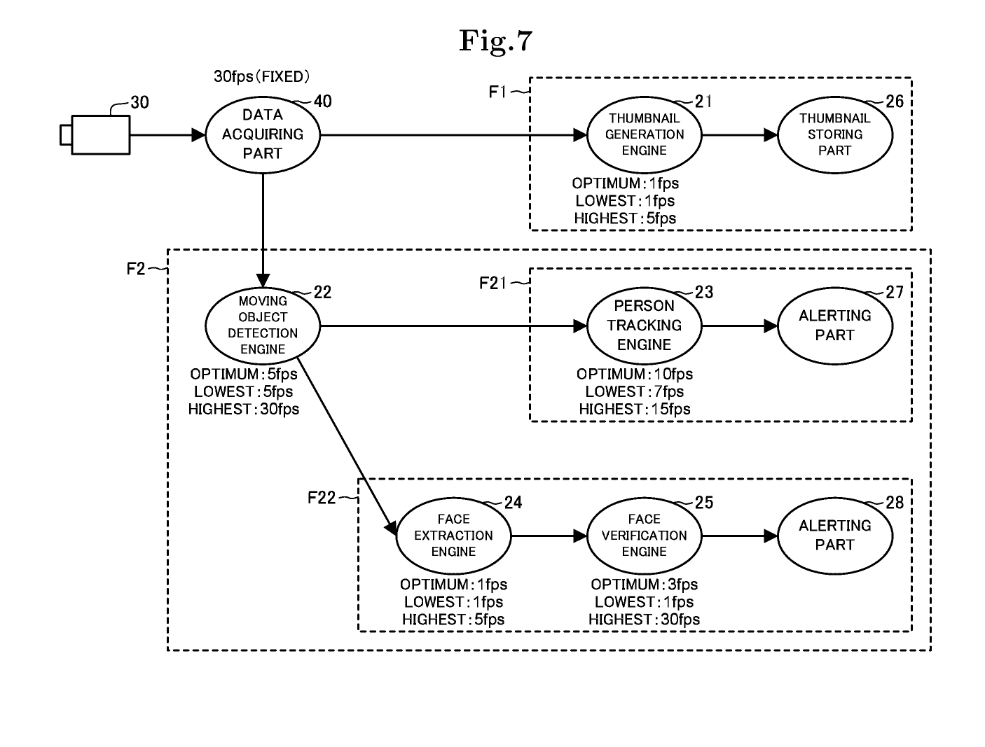

A first exemplary embodiment of the present invention will be described referring to FIGS. 1 to 10. FIGS. 1 to 5 are diagrams for describing the configuration of an analysis system according to this exemplary embodiment, and FIGS. 6 to 10 are diagrams for describing the operation of the analysis system.

The analysis system shown in FIG. 1 includes an analysis device 10 configured by one information processing device or a plurality of information processing devices, a plurality of analysis engines 20 each executing a predetermined analysis process, a plurality of cameras 30 each capturing a video image, and a data acquiring part 40 acquiring video images captured by the cameras 30.

The cameras 30 are for acquiring video data (stream data) that becomes analysis target data in this exemplary embodiment. For this purpose, the cameras 30 are placed at a plurality of preset sites, and each captures a video image of the site where the camera is placed and outputs data of the captured video image to the data acquiring part 40. The analysis target data in the analysis system of the present invention is not limited to video data, and may be any data such as speech data or image data.

The data acquiring part 40 acquires the outputted data of the video images captured by the cameras 30 with a preset quality, that is, at preset resolution and frame rate. For example, the data acquiring part 40 acquires the video data with a quality that the resolution is 640×480 [dpi] and the frame rate is 30 [fps].

The analysis engines 20, whose operations are controlled by the analysis device 10, analyze video data of analysis target data. To be specific, the analysis engines 20 in this exemplary embodiment are a thumbnail generation engine that generates a thumbnail image from the video data, a moving object detection engine that detects a person in the video data, a person tracking engine that tracks the trajectory of the detected person, a face extraction engine that extracts the facial part of the detected person, and a face verification engine that checks the extracted facial part against previously registered faces and identifies the person. However, the analysis engines 20 are not limited to analysis engines executing the abovementioned analysis processes, and may be analysis engines executing other analysis processes.

Next, the configuration of the analysis device 10 will be described. As shown in FIG. 1, the analysis device 10 has an analysis process executing part 11 and a resolving power determining part 12, which are structured by installation of a program into a provided arithmetic device. Moreover, the analysis device 10 has a process flow storing part 15 and a characteristics information storing part 16 in a provided storage device. Below, the respective components will be described in detail.

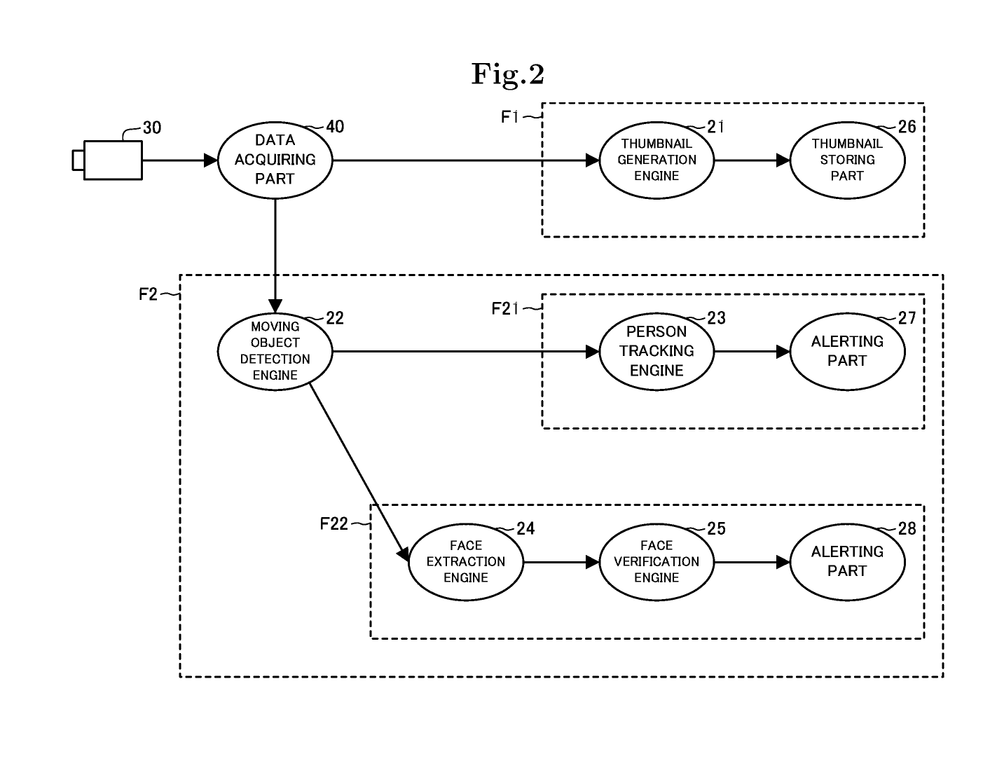

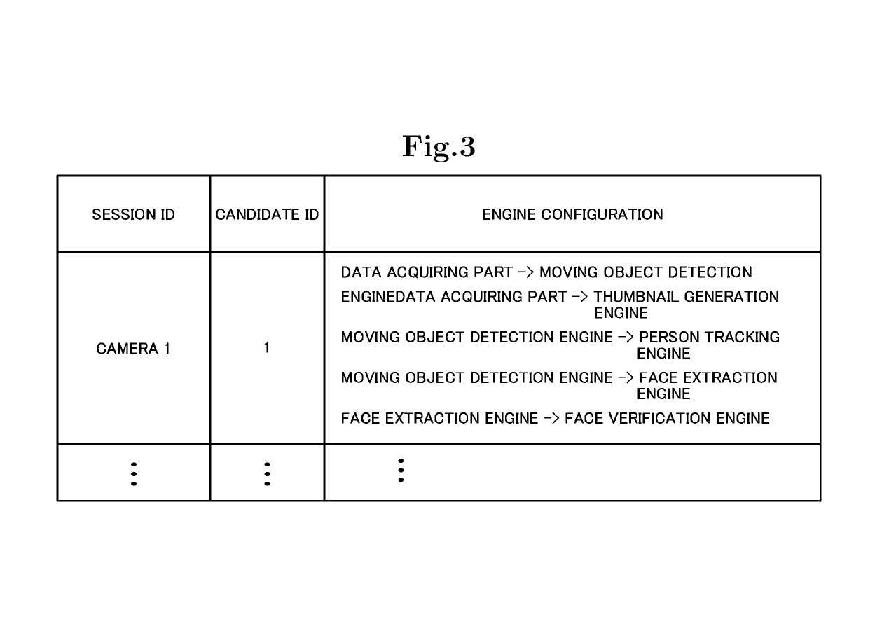

The process flow storing part 15 (an analysis process flow storing means) stores an analysis process flow showing the order of analysis by combination of the analysis engines 20 described above. An example of the analysis process flow stored in this exemplary embodiment is shown by FIGS. 2 and 3.

As shown in FIG. 2, the analysis process flow in this exemplary embodiment has a flow F1 in which, from video data acquired by the data acquiring part 40, a thumbnail generation engine 21 generates a thumbnail image that is a predetermined size of still image showing one scene of the video data and a thumbnail storing part 26 stores the generated thumbnail image. This flow F1, which is the flow from the analysis by the thumbnail generation engine 21 to the analysis by the thumbnail storing part 26, is specified by the resolving power determining part 12 as a serial flow portion (a serial flow analysis engine part) in which processes are arranged in serial order as described later. The thumbnail storing part 26 is a partial function of the thumbnail generation engine 21, or a partial function of the analysis process executing part 11.

Further, in the analysis process flow, a moving object detection engine 22 detects a moving object such as a person from the video image acquired by the data acquiring part 40 based on a preset criterion. Then, a person tracking engine 23 tracks the person detected by the moving object detection engine 22 and, when it is determined that the trajectory of the person is the same as a specific trajectory based on a preset criterion, an alerting part 27 alerts a monitoring person, or the like. Moreover, a face extraction engine 24 extracts a facial portion from the person detected by the moving object detection engine 22 based on a preset criterion, and a face verification engine 25 checks whether the extracted facial portion matches previously registered facial data. When the extracted facial portion matches the previously registered facial data, an alerting part 28 alerts a manager, or the like. The alerting parts 27 and 28 are partial functions of the respective analysis engines, or a partial function of the analysis process executing part 11.

A flow F2 including the abovementioned analysis by the moving object detection engine 22, the person tracking engine 23 and the alerting part 27 and the abovementioned analysis by the moving object detection engine 22, the face extraction engine 24, the face verification engine 25 and the alerting part 28 is specified by the resolving power determining part 12 as a serial flow portion in which processes are arranged in serial order as a whole, though the processes are split into the person tracking engine 23 and the face extraction engine 24 from the moving object detection engine 22. Moreover, a flow F21 from the analysis by the person tracking engine 23 to the analysis by the alerting part 27 and a flow F22 from the analysis by the face extraction engine 24 to the analysis by the face verification engine 25 and then the analysis by the alerting part 28, which are on the low-order side of the split point on the low-order side of the moving object detection engine 22, are each specified as a serial sub-flow portion (a sub-flow analysis engine part) by the resolving power determining part 12 to be described later.

The analysis process flow stored in the process flow storing part 15 may be stored by graph expression described above or, as shown in FIG. 3, may be composed of data that represents the order of analysis engines through which acquired processing target data flows, for each of the cameras 30.

Next, data stored in the characteristics information storing part 16 (an engine characteristics information storing means) will be described. The characteristics information storing part 16 stores engine characteristics information including a quality characteristic of processing target data inputted into each of the analysis engines and an accuracy characteristic of the analysis engine associated with each other, and engine resources characteristics information representing a resources characteristic of each of the analysis engines.

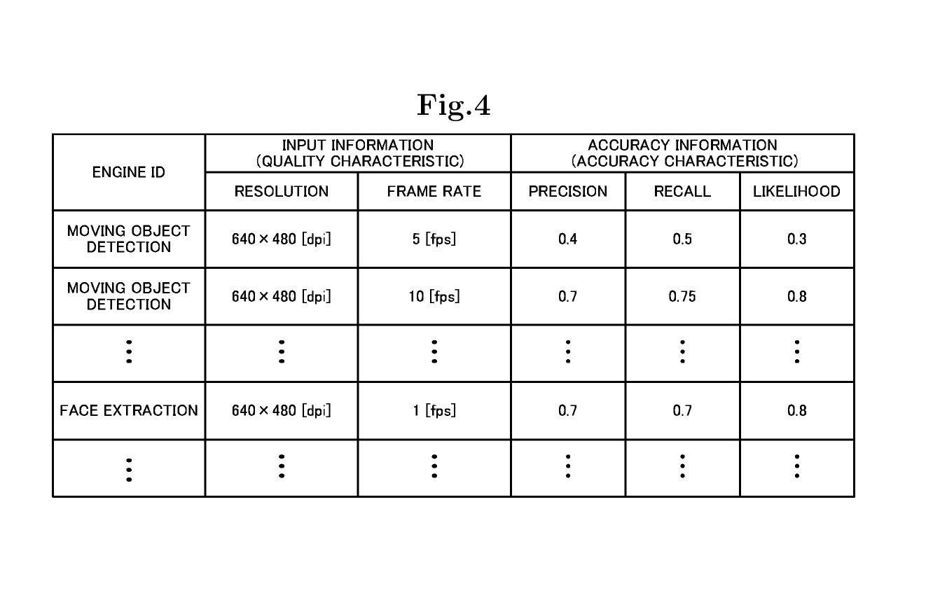

In the engine characteristics information, for each of the analysis engines, a quality characteristic representing the quality of analysis target data inputted into the analysis engine and an accuracy characteristic representing the accuracy of the result of analysis by the analysis engine when analysis target data of the abovementioned quality is inputted are associated with each other. FIG. 4 shows an example of the engine characteristics information. In the example shown by FIG. 4, resolution [dpi] and a frame rate [fps] are set as input information representing the quality characteristic of video data of analysis target data inputted into each of the analysis engines. Moreover, precision that is an index showing how correct an analysis result is, recall that is an index showing how complete the analysis result is, and likelihood that is an index showing how likely the analysis result is are set as accuracy information representing the accuracy characteristic of each of the analysis engines. Thus, for example, the moving object analysis engine shown on the first line in FIG. 4 is set so that analysis result accuracy of precision 0.4, recall 0.5 and likelihood 0.3 can be obtained by inputting analysis target data of quality of 640×480 [dpi] as resolution and 5 [fps] as the frame rate.

The abovementioned analysis result accuracy will be described in more detail. The precision is a value representing the proportion of true results (TP) to results determined as true in analysis (TP+NP), and can be expressed as precision=TP/(TP+NP). For example, the precision in a case where the face detection engine detects ten faces from a video image and seven of the ten faces are truly faces is expressed as 7/10=0.7. Moreover, the recall is a value representing the proportion of results actually determined as true (TP) to results that should be determined as true in analysis (TP+FN), and can be expressed as recall=TP/(TP+FN). For example, the recall in a case where the faces of fourteen people are captured in a video image, the face detection engine detects ten faces, and seven of the ten faces are truly faces is expressed as 7/14=0.5. Moreover, the likelihood can be expressed as shown below, for example. When an event A is observed, likelihood L(b|A) of B=b can be defined as L(b|A)=P(A|B=b), where P(A|B=b) represents a probability of occurrence of A when B=b. As one example, when a face is detected (A), the likelihood that the face is truly a face (B=b) is L(b|A)=P(A|B=b). If a probability that the face detection engine detects a face is 90% (P(A|B=b)), the likelihood is L(b|A)=0.9.

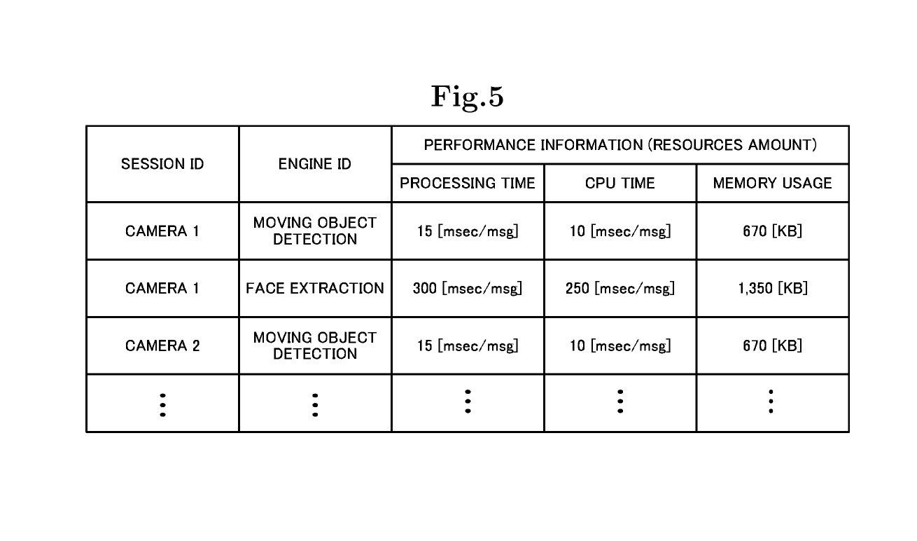

Further, in the engine resources characteristics information, for each of the analysis engines, the amount of resources used for the analysis by the analysis engine is stored. FIG. 5 shows an example of the engine resources characteristics information. In the example shown by FIG. 5, a processing time, a CPU time, and memory usage that are required for each of the analysis engines to analyze processing target data of predetermined quality and predetermined unit are set as the amount of resources. For example, it is set that the moving object detection engine that processing target data is inputted from a camera 1 shown on the first line in FIG. 5 needs the processing time of 15 [msec/msg], the CPU time of 10 [msec/msg] and the memory usage of 670 [KB] as the amount of resources.

The quality and accuracy characteristics of processing target data and the amount of resources described above are merely presented as one example, and values of other contents may be stored as the engine characteristics information and the engine resources characteristics information.

Next, the functions of the resolving power determining part 12 (an input quality regulating means) and the analysis process executing part 11 will be described together with the operations thereof. The resolving power determining part 12 determines and regulates the quality characteristic of processing target data inputted into each of the analysis engines, based on the engine characteristics information and the engine resources characteristics information stored in the characteristics information storing part 16 and the analysis process flow stored in the process flow storing part 15. Because the quality of processing target data to be determined and regulated is a frame rate herein, the quality will be simply referred to as a rate or a resolving power.

To be specific, by referring to the engine characteristics information and the engine resources characteristics information, the resolving power determining part 12 first determines a quality characteristic of processing target data inputted into each of the analysis engines 20 so that a requirement for analysis result accuracy and a requirement for a resources amount that are previously set and required are satisfied (in FIG. 6, Yes at step S1, and step S2). At this time, for each of the analysis engines, the resolving power determining part 12 sets a quality characteristic of processing target data that allows output of an analysis result satisfying the accuracy of the set accuracy requirement, as a lowest rate that is the lowest quality. Moreover, in a case where the upper limit values of the allowable CPU use time, memory usage and so on are set as the requirement for the resources amount, for each of the analysis engines, the resolving power determining part 12 sets a quality characteristic of processing target data that can be processed at the above resources amount (the requirement for the resources amount), as a highest rate.

Further, the resolving power determining part 12 also sets an optimum rate that becomes an optimum quality characteristic of processing target data inputted into each of the analysis engines, based on the determined lowest rate and highest rate. For example, the value of the lowest rate may be used as the optimum rate, and a value between the lowest rate and the highest rate is set based on a preset criterion. As one example, in a case where the analysis result accuracy increases though an increase of the used resources amount is a little, a quality characteristic of processing target data inputted when the resources amount is used is set as the optimum rate. Thus, the resolving power determining part 12 determines a quality characteristic including the optimum rate, the lowest rate and the highest rate for each of the analysis engines 21 to 25.

Subsequently, the resolving power determining part 12 retrieves information of the analysis process flow from the process flow storing part 15, and specifies a serial flow portion which is formed by one or plural analysis engines and which contains processes arranged in serial order based on a preset criterion (step S3 in FIG. 6). For example, in a case where the analysis process flow is one shown by FIG. 2 or FIG. 3, two serial flow portions denoted by symbols F1 and F2 and shown by dotted lines in FIG. 2.

Further, the resolving power determining part 12 checks whether there is a split in each of the serial flow portions F1 and F2 (in FIG. 6, No at step S4, and step S5). In a case where there is a split (Yes at step S5 in FIG. 6), the resolving power determining part 12 specifies a serial sub-flow portion which is on the downstream side (on the low-order side) from the split point, which contains processes arranged in serial order based on a preset criterion, and which is formed by one or plural analysis engines. For example, in the example shown by FIG. 2, two serial sub-flow portions denoted by reference symbols F21 and F22 and shown by dotted lines in the serial flow portion F2 are specified. In a case where there is also a split in the specified serial sub-flow portions, the resolving power determining part 12 further specifies a serial sub-flow portion on the downstream side from the split point.

Subsequently, the resolving power determining part 12 regulates and determines a quality characteristic of processing target data inputted into an analysis engine arranged in the highest order in each of the serial flow portion and the serial sub-flow portions, based on the quality characteristics of the respective analysis engines (steps S6, S7, S8 and S9 in FIG. 6).

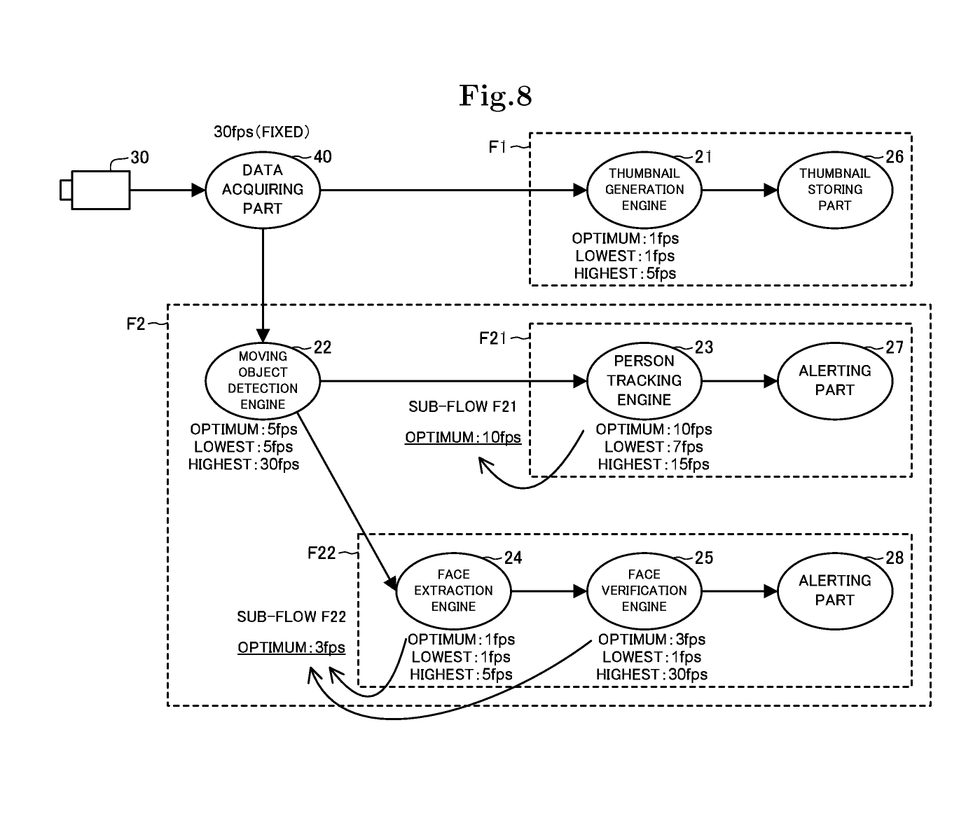

For example, firstly, with regard to the serial sub-flow portion F21, because only the person tracking engine 23 is in the serial sub-flow portion F21, an optimum rate 10 fps that is a quality characteristic determined for the person tracking engine 23 is set as an optimum rate (see FIG. 8). Moreover, with regard to the serial sub-flow portion F22, because the face extraction engine 24 and the face verification engine 25 are in the serial sub-flow portion F21, a largest value 3 fps of optimum rates 1 fps and 3 fps that are quality characteristics determined for the respective engines is set as an optimum rate (see FIG. 8). Thus, the resolving powers of the respective analysis engines in the serial sub-flow portions F21 and F22 are determined.

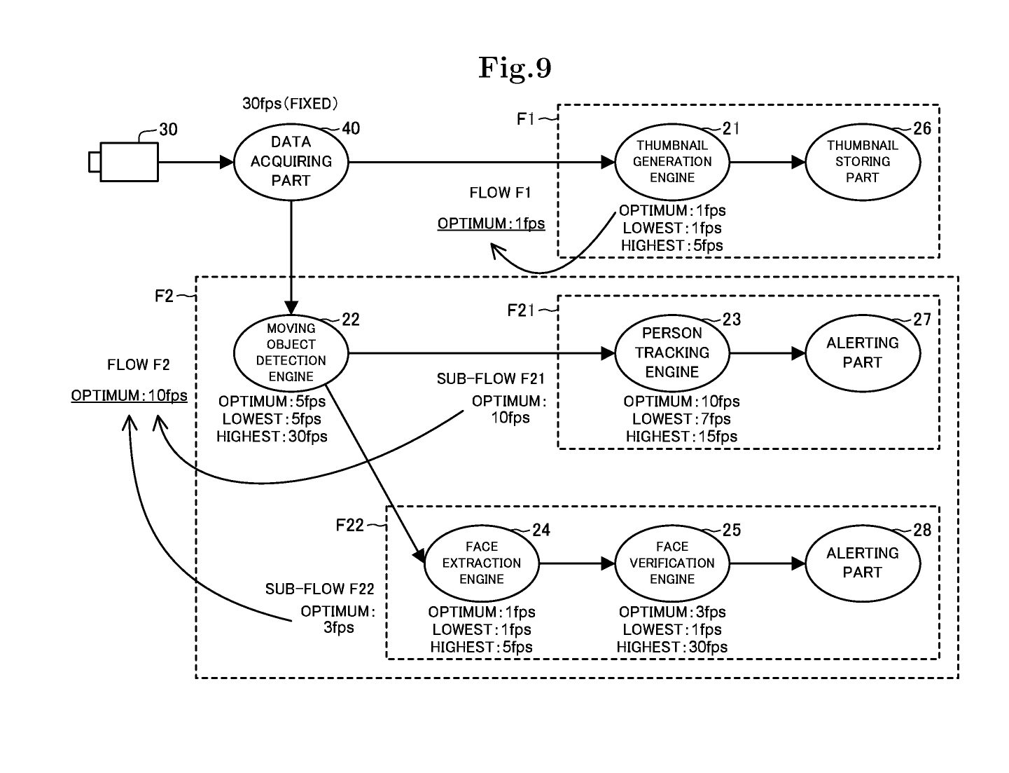

Further, with regard to the serial flow portion F2, because the serial sub-flow portion F21 and the serial sub-flow portion F22 are downstream of the serial flow portion F2, a largest value 10 fps of optimum rates 10 fps and 3 fps that are quality characteristics determined for the respective engines is set as an optimum rate (see FIG. 9). With regard to the serial flow portion F1, because there is no split downstream of the serial flow portion F1, an optimum rate 1 fps of the thumbnail generation engine 21 is set as an optimum rate (step S9 in FIG. 6) (see FIG. 9).

As described above, the resolving power determining part 12 regulates the quality characteristics of processing target data inputted into the analysis engine arranged in the highest order in each of the serial flow portion and the serial sub-flow portions so as to become the largest value of the quality characteristic determined for the analysis engine arranged on the low-order side from the analysis engine arranged in the highest order. Thus, it is possible to set the quality characteristics of processing target data in the whole analysis process flow (steps S10 and S11 in FIG. 6). The quality characteristic of the serial flow portion F2 described above is not limited to being regulated based on the quality characteristics of the serial sub-flow portions F21 and F22 as described above, and may be regulated based on quality characteristics determined for all of the analysis engines in the serial flow portion F2.

In the above description, a quality characteristic of processing target data inputted into each of the analysis engines is determined based on engine characteristics information and engine resources characteristics information set for the analysis engine, but may be determined based on only the engine characteristics information. In this case, for each of the analysis engines, a lowest rate that satisfies a predetermined accuracy requirement at the minimum is determined as a quality characteristic of processing target data.

Further, in the above description, a case where a frame rate of video data that is processing target data is determined as a quality characteristic of processing target data inputted into each of the analysis engines is illustrated, but resolution of video data may be determined as a quality characteristic thereof. However, a quality characteristic of processing target data is not limited to a frame rate or resolution.

The analysis process executing part 11 (an analysis process executing means) controls so as to analyze video data inputted from the camera 30 by a procedure based on the analysis process flow stored in the process flow storing part 15. At this time, the analysis process executing part 11 controls a quality characteristic of video data that is processing target data inputted into each of the analysis engines.

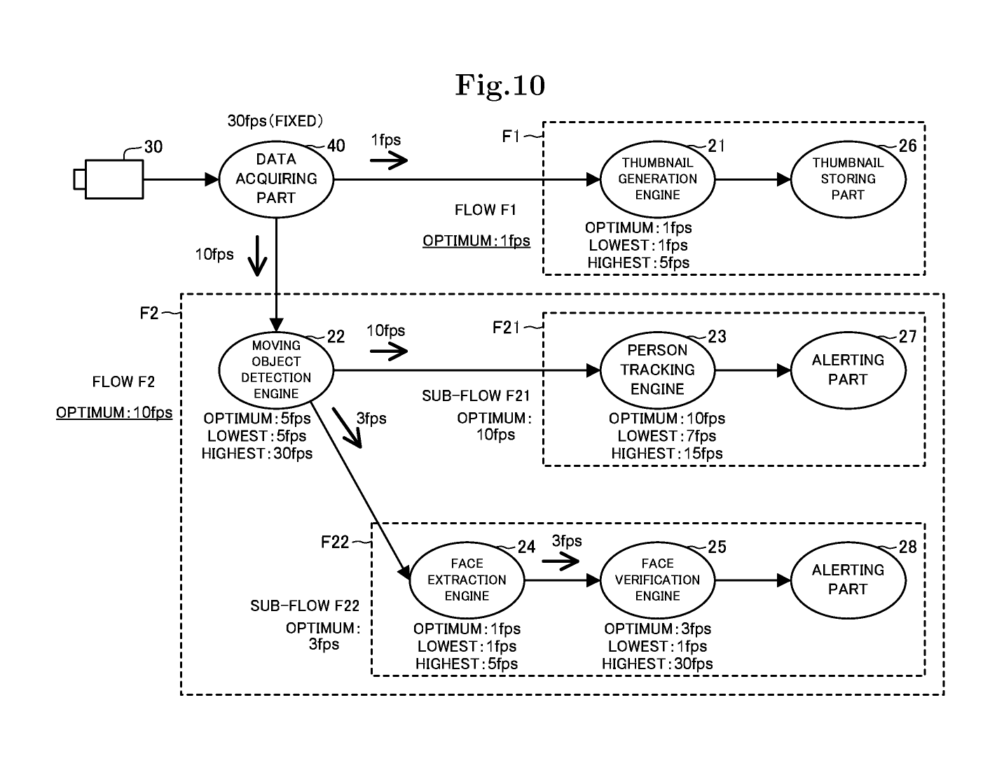

To be specific, the analysis process executing part 11 controls so that, into the analysis engine arranged in the highest order in each of the serial flow portions F1 and F2 and the serial sub-flow portions F21 and F22, processing target data of a quality corresponding to a quality characteristic regulated for the highest-order analysis engine is inputted. For example, as shown in FIG. 10, video data of a quality of 30 fps is inputted into the data acquiring part 40 from the camera 30, and the analysis process executing part 11 controls so that, into the serial flow portion F1 arranged on the low-order side from the data acquiring part 40, processing target data of a quality of 1 fps regulated for the thumbnail generation engine 21 arranged in the highest order in the serial flow portion F1 is inputted. Likewise, the analysis process executing part 11 controls so that, into the serial flow portion F2 arranged on the low-order side from the data acquiring part 40, processing target data of a quality of 10 fps regulated for the moving object detection engine 22 arranged in the highest order in the serial flow portion F2 is inputted.

Further, the analysis process executing part 11 controls so that, into the serial sub-flow portion F21 arranged on the low-order side in the serial flow portion F2, processing target data of a quality of 10 fps regulated for the person tracking engine 23 arranged in the highest order in the serial sub-flow portion F21 is inputted. The analysis process executing part 11 controls so that, into the serial sub-flow portion F22 arranged on the low-order side in the serial flow portion F2, processing target data of a quality of 3 fps regulated for the face extraction engine 24 arranged in the highest order in the serial sub-flow portion F22 is inputted.

An analysis engine into which processing target data of a quality of an optimum rate or more is inputted may execute an analysis process by using only processing target data of a required quality. For example, although the optimum rate for the moving object detection engine is 5 fps, processing target data of 10 fps is inputted into the moving object detection engine, and therefore, the inputted processing target data may be thinned out so that only data of 5 fps is used.

Thus, processing target data of a quality required to obtain an analysis result satisfying a required accuracy requirement is inputted into each of the analysis engines. Therefore, the results of analysis by the respective analysis engines can satisfy the accuracy requirement, and it is possible to easily design an analysis processing system capable of producing a necessary analysis result.

### Second Exemplary Embodiment

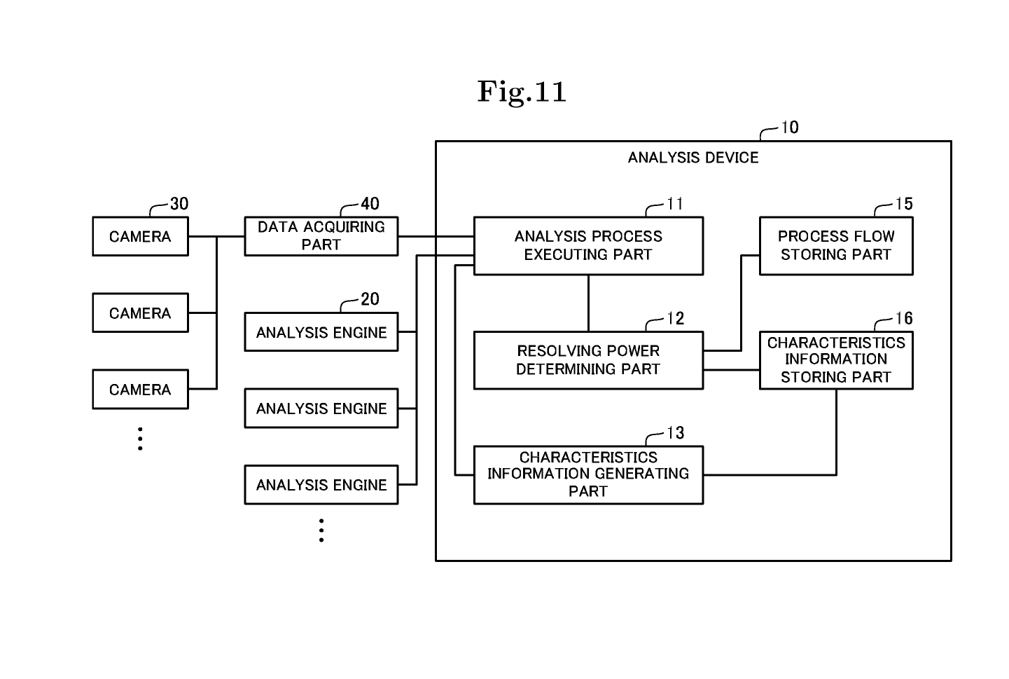

Next, a second exemplary embodiment of the present invention will be described referring to FIG. 11. FIG. 11 is a diagram for describing the configuration of an analysis system according to this exemplary embodiment.

The analysis system of this exemplary embodiment has almost the same configuration as that of the first exemplary embodiment. In addition, as shown in FIG. 11, the analysis system according to this exemplary embodiment has a characteristics information generating part 13 as shown in FIG. 11.

The characteristics information generating part 13 (an engine characteristics information generating means, an engine resources characteristics information generating means) newly generates engine characteristics information and engine resources characteristics information stored in the characteristics information storing part 16 described in the first exemplary embodiment, and stores into the characteristics information storing part 16. Moreover, in a case where engine characteristics information and engine resources characteristics information are already stored in the characteristics information storing part 16, the characteristics information generating part 13 updates the information.

To be specific, the characteristics information generating part 13 requests the analysis process executing part 11 controlling the operations of the analysis engines 20 to measure a quality characteristic of processing target data inputted into each of the analysis engines 20 and an accuracy characteristic of the result of analysis by each of analysis engines 20 when the processing target data having the above quality characteristic is inputted, and acquires the quality characteristic and the accuracy characteristic. Then, for each of the analysis engines 20, the characteristics information generating part 13 associates the acquired quality characteristic and accuracy characteristic with each other to generate engine characteristics information, and stores the generated engine characteristics information as new engine characteristics information into the characteristics information storing part 16.

Likewise, the characteristics information generating part 13 requests the analysis process executing part 11 controlling the operations of the analysis engines 20 to measure a resources characteristic that is the amount of resources used when each of the analysis engines 20 analyzes data of a predetermined unit, and acquires the resources characteristic. Then, for each of the analysis engines 20, the characteristics information generating part 13 generates engine resources characteristics information from the acquired resources characteristic, and stores the generated engine resources characteristics information as new engine resources characteristics information into the characteristics information storing part 16.

After that, as in the first exemplary embodiment described above, the characteristics information generating part 13 determines and regulates a quality characteristic of processing target data inputted into each of the analysis engines based on the engine characteristics information and engine resources characteristics information stored in the characteristics information storing part 16.

Thus, even when change of analysis engines, variation of the amount of resources, or variation of the data content of processing target data occurs, proper engine characteristics information and engine resources characteristics information are set in response to the change or the variation. Therefore, it is possible to easily design an analysis system capable of producing necessary analysis results at all times.

### Third Exemplary Embodiment

Next, a third exemplary embodiment of the present invention will be described. An analysis system of this exemplary embodiment has almost the same configuration as that of the first exemplary embodiment disclosed in FIG. 1. However, the analysis system of this exemplary embodiment is different in that the characteristics information storing part 16 (a resources allocation information storing means) stores resources allocation information.

The resources allocation information, which is information representing the proportion of the amount of resources of the information processing device allocated to each of the analysis engines 20, is previously set depending on the type and importance of the analysis engine and the camera 30 that captures processing target data. For example, the resources allocation information is set so that resources such as a CPU time and a memory amount are allocated more to a specific analysis engine that processes processing target data captured by a specific camera 30.

Then, the resolving power determining part 12 (an input quality regulating means) in this exemplary embodiment sets a requirement for a resources amount that each of the analysis engines 20 is allowed to use, based on the stored resources amount allocation information, and determines a quality characteristic of processing target data inputted into each of the analysis engines so as to satisfy the resources amount requirement.

Thus, for example, by previously allocating a large amount of resources to an analysis engine executing an analysis process set as important, it is possible to properly deal with variation of the data content of data that is the target of variation of a resources amount of an analysis engine. As a result, it is possible to easily design an analysis system capable of producing necessary analysis results.

### <Supplementary Notes>

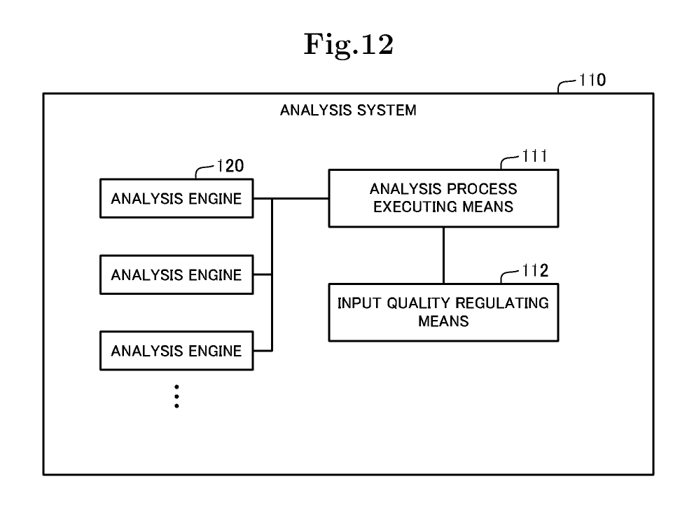

The whole or part of the exemplary embodiments disclosed above can be described as the following supplementary notes. Below, the overview of the configurations of an analysis system (see FIG. 12), a computer program and an analysis method will be described. However, the present invention is not limited to the following configurations.

### (Supplementary Note 1)

An analysis system 110 comprising:

an analysis process executing means 111 for controlling operation of the analysis system 110 to execute an analysis process, the analysis system 110 configured by a plurality of analysis engines 120 executing predetermined analysis processes, respectively; and

an input quality regulating means 112 for determining quality characteristics of processing target data inputted into the respective analysis engines 120 so as to satisfy a preset requirement for accuracy of an analysis result, and regulating the quality characteristic of the processing target data inputted into a given one of the analysis engines 120 configuring the analysis system 110 based on the determined quality characteristics,

wherein the analysis process executing means 111 is configured to control the operation of the analysis system 110 so as to input the processing target data of quality corresponding to the quality characteristic regulated by the input quality regulating means 112 into the given analysis engine 120.

### (Supplementary Note 2)

The analysis system according to Supplementary Note 1, comprising an analysis process flow storing means for storing an analysis process flow showing a sequence of analyses by the plurality of analysis engines,

wherein the input quality regulating means is configured to regulate the quality characteristic of the processing target data inputted into the given analysis engine, based on the quality characteristics of the processing target data inputted into the respective analysis engines and based on the analysis process flow, the quality characteristics being determined by the input quality regulating means.

### (Supplementary Note 3)

The analysis system according to Supplementary Note 2, wherein the input quality regulating means is configured to regulate the quality characteristic of the processing target data inputted into the given analysis engine, based on the quality characteristic of the processing target data inputted into another one of the analysis engines that is arranged on a low-order side of the given analysis engine in a processing sequence in the analysis process flow, the quality characteristic of the processing target data inputted into the other analysis engine being determined for the other analysis engine.

### (Supplementary Note 4)

The analysis system according to Supplementary Note 3, wherein the input quality regulating means is configured to: based on the analysis process flow, specify a serial flow analysis engine part in which a processing sequence is serial according to a preset criterion and which includes one of the analysis engines or a group of the analysis engines; and, consider the analysis engine arranged in a highest order in the serial flow analysis engine part as the given analysis engine, and regulate the quality characteristic of the processing target data inputted into the given analysis engine, based on the quality characteristics of the processing target data inputted into the respective analysis engines, the quality characteristics being determined for the respective analysis engines included by the serial flow analysis engine part.

### (Supplementary Note 5)

The analysis system according to Supplementary Note 4, wherein the input quality regulating means is configured to set a largest value of the quality characteristics of the processing target data inputted into the respective analysis engines as the quality characteristic of the given analysis engine, the quality characteristics being determined for the respective analysis engines included by the serial flow analysis engine part.

### (Supplementary Note 6)

The analysis system according to Supplementary Note 4 or 5, wherein:

the input quality regulating means is configured to: based on the analysis process flow, specify a point where a processing sequence is split in the serial flow analysis engine part, and specify a sub-flow analysis engine part which is arranged on a low-order side of the split point, in which a processing sequence is serial according to a preset criterion, and which includes one of the analysis engines or a group of the analysis engines; and regulate the quality characteristic of the processing target data inputted into the analysis engine arranged in a highest order in the sub-flow analysis engine part, based on the quality characteristics of the processing target data inputted into the respective analysis engines, the quality characteristics being determined for the respective analysis engines included by the sub-flow analysis engine part; and

the analysis process executing means is configured to control the operation of the analysis system so as to input, into the analysis engine arranged in a highest order in the sub-flow analysis engine part, the processing target data of quality corresponding to the quality characteristic of the processing target data inputted into the analysis engine arranged in the highest order in the sub-flow analysis engine part, the quality characteristic being regulated by the input quality regulating means.

### (Supplementary Note 7)

The analysis system according to any of Supplementary Notes 1 to 6, comprising an engine characteristics information storing means for storing, for each of the analysis engines, engine characteristics information in which a quality characteristic of processing target data inputted into the analysis engine and an accuracy characteristic of a result of analysis by the analysis engine are previously associated and set,

wherein the input quality regulating means is configured to determine the quality characteristic of the processing target data inputted into each of the analysis engines so as to satisfy a preset requirement for accuracy of an analysis result, based on the engine characteristics information.

### (Supplementary Note 8)

The analysis system according to Supplementary Note 7, wherein:

the engine characteristics information storing means is configured to store, for each of the analysis engines, engine resources characteristics information in which a resources characteristic representing an amount of resources used for an analysis process by the analysis engine is previously set; and

the input quality regulating means is configured to determine the quality characteristic of the processing target data inputted into each of the analysis engines so as to satisfy a preset requirement for accuracy of an analysis result and a preset requirement for a resources amount of an analysis process.

### (Supplementary Note 9)

The analysis system according to Supplementary Note 7 or 8, comprising an engine characteristics information generating means for: causing the analysis process executing means to, for each of the analysis engines, measure a quality characteristic of the processing target data inputted into the analysis engine whose operation is controlled by the analysis process executing means and an accuracy characteristic of a result of analysis by the analysis engine, acquiring the quality characteristic and the accuracy characteristic from the analysis process executing means, generating the engine characteristics information by associating the acquired quality characteristic and the acquired accuracy characteristic, and storing the engine characteristics information into the engine characteristics information storing means; or updating the engine characteristics information stored in the engine characteristics information storing means.

### (Supplementary Note 10)

The analysis system according to Supplementary Note 8, comprising an engine resources characteristics information generating means for: causing the analysis process executing means to, for each of the analysis engines, measure a resources characteristic representing an amount of resources used in an analysis process by the analysis engine whose operation is controlled by the analysis process executing means, acquiring the resources characteristic from the analysis process executing means, generating the engine resources characteristics information including the acquired resources characteristics, and storing the engine resources characteristics information into the engine characteristics information storing means; or updating the engine resources characteristics information stored in the engine characteristics information storing means.

### (Supplementary Note 11)

The analysis system according to Supplementary Note 8 or 10, comprising a resources allocation information storing means for storing preset resources allocation information showing allocation of resources to the analysis engines,

wherein the input quality regulating means is configured to set the resources amount requirement based on the resources allocation information, and determine the quality characteristic of the processing target data inputted into each of the analysis engines so as to satisfy the resources amount requirement.

### (Supplementary Note 12)

A computer program comprising instructions for causing an information processing device, which controls operation of an analysis system configured by combining a plurality of analysis engines executing predetermined analysis processes, respectively, to execute an analysis process, to realize:

an input quality regulating means for determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics; and

an analysis process executing means for inputting the processing target data of quality corresponding to the quality characteristic regulated by the input quality regulating means into the given analysis engine, and controlling the operation of the analysis system to execute an analysis process.

### (Supplementary Note 13)

The computer program according to Supplementary Note 12, wherein the input quality regulating means is configured to regulate the quality characteristic of the processing target data inputted into the given analysis engine, based on the quality characteristics of the processing target data inputted into the respective analysis engines and based on a previously stored analysis process flow showing a sequence of analyses by the plurality of analysis engines, the quality characteristics being determined by the input quality regulating means.

### (Supplementary Note 14)

An analysis method for controlling operation of an analysis system configured by combining a plurality of analysis engines executing predetermined analysis processes, respectively, to execute an analysis process, the analysis method comprising:

determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics; and

inputting the processing target data of quality corresponding to the regulated quality characteristic into the given analysis engine, and controlling the operation of the analysis system to execute an analysis process.

### (Supplementary Note 15)

The analysis method according to Supplementary Note 13, wherein an analysis process flow showing a sequence of analyses by the plurality of analysis engines is stored,

the analysis method comprising:

regulating the quality characteristic of the processing target data inputted into the given analysis engine, based on the quality characteristics of the processing target data inputted into the respective analysis engines and based on the analysis process flow, the quality characteristics being determined based on engine characteristics information.

The abovementioned computer program is stored in a storage device, or recorded on a computer-readable recording medium. For example, the recording medium is a portable medium such as a flexible disk, an optical disk, a magneto-optical disk, and a semiconductor memory.

Although the present invention is described above referring to the exemplary embodiments and so on, the present invention is not limited to the exemplary embodiments described above. The configurations and details of the present invention can be changed and modified in various manners that can be understood by one skilled in the art within the scope of the present invention.

The present invention is based upon and claims the benefit of priority from Japanese patent application No. 2012-046674, filed on Mar. 2, 2012, the disclosure of which is incorporated herein in its entirety by reference.

### DESCRIPTION OF REFERENCE NUMERALS

10 analysis device
11 analysis process executing part
12 resolving power determining part
15 process flow storing part
16 characteristics information storing part
20 analysis engine
21 thumbnail generation engine
22 moving object detection engine
23 person tracking engine
24 face extraction engine
25 face verification engine
26 thumbnail storing part
27, 28 alerting part
30 camera
40 data acquiring part
110 analysis system
111 analysis processing executing means
112 input quality regulating means
120 analysis engine
F1, F2 serial flow portion
F21, F22 serial sub-flow portion

What is claimed is:

1.-15. (canceled)

16. An analysis system comprising:
an analysis process executing unit for controlling operation of the analysis system to execute an analysis process, the analysis system configured by a plurality of analysis engines executing predetermined analysis processes, respectively; and
an input quality regulating unit for determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics,
wherein the analysis process executing unit is configured to control the operation of the analysis system so as to input the processing target data of quality corresponding to the quality characteristic regulated by the input quality regulating unit into the given analysis engine.

17. The analysis system according to claim 16, comprising an analysis process flow storing unit for storing an analysis process flow showing a sequence of analyses by the plurality of analysis engines,
wherein the input quality regulating unit is configured to regulate the quality characteristic of the processing target data inputted into the given analysis engine, based on the quality characteristics of the processing target data inputted into the respective analysis engines and based on the analysis process flow, the quality characteristics being determined by the input quality regulating unit.

18. The analysis system according to claim 17, wherein the input quality regulating unit is configured to regulate the quality characteristic of the processing target data inputted into the given analysis engine, based on the quality characteristic of the processing target data inputted into another one of the analysis engines that is arranged on a low-order side of the given analysis engine in a processing sequence in the analysis process flow, the quality characteristic of the processing target data inputted into the other analysis engine being determined for the other analysis engine.

19. The analysis system according to claim 18, wherein the input quality regulating unit is configured to: based on the analysis process flow, specify a serial flow analysis engine part in which a processing sequence is serial according to a preset criterion and which includes one of the analysis engines or a group of the analysis engines; and, consider the analysis engine arranged in a highest order in the serial flow analysis engine part as the given analysis engine, and regulate the quality characteristic of the processing target data inputted into the given analysis engine, based on the quality characteristics of the processing target data inputted into the respective analysis engines, the quality characteristics being determined for the respective analysis engines included by the serial flow analysis engine part.

20. The analysis system according to claim 19, wherein the input quality regulating unit is configured to set a largest value of the quality characteristics of the processing target data inputted into the respective analysis engines as the quality characteristic of the given analysis engine, the quality characteristics being determined for the respective analysis engines included by the serial flow analysis engine part.

21. The analysis system according to claim 19, wherein:
the input quality regulating unit is configured to: based on the analysis process flow, specify a point where a processing sequence is split in the serial flow analysis engine part, and specify a sub-flow analysis engine part which is arranged on a low-order side of the split point, in which a processing sequence is serial according to a preset criterion, and which includes one of the analysis engines or a group of the analysis engines; and regulate the quality characteristic of the processing target data inputted into the analysis engine arranged in a highest order in the sub-flow analysis engine part, based on the quality characteristics of the processing target data inputted into the respective analysis engines, the quality characteristics being determined for the respective analysis engines included by the sub-flow analysis engine part; and
the analysis process executing unit is configured to control the operation of the analysis system so as to input, into the analysis engine arranged in a highest order in the sub-flow analysis engine part, the processing target data of quality corresponding to the quality characteristic of the processing target data inputted into the analysis engine arranged in the highest order in the sub-flow analysis engine part, the quality characteristic being regulated by the input quality regulating unit.

22. The analysis system according to claim 16, comprising an engine characteristics information storing unit for storing, for each of the analysis engines, engine characteristics information in which a quality characteristic of processing target data inputted into the analysis engine and an accuracy characteristic of a result of analysis by the analysis engine are previously associated and set,
wherein the input quality regulating unit is configured to determine the quality characteristic of the processing target data inputted into each of the analysis engines so as to satisfy a preset requirement for accuracy of an analysis result, based on the engine characteristics information.

23. The analysis system according to claim 22, wherein:
the engine characteristics information storing unit is configured to store, for each of the analysis engines, engine resources characteristics information in which a resources characteristic representing an amount of resources used for an analysis process by the analysis engine is previously set; and
the input quality regulating unit is configured to determine the quality characteristic of the processing target data inputted into each of the analysis engines so as to satisfy a preset requirement for accuracy of an analysis result and a preset requirement for a resources amount of an analysis process.

24. The analysis system according to claim 22, comprising an engine characteristics information generating unit for: causing the analysis process executing unit to, for each of the analysis engines, measure a quality characteristic of the processing target data inputted into the analysis engine whose operation is controlled by the analysis process executing unit and an accuracy characteristic of a result of analysis by the analysis engine, acquiring the quality characteristic and the accuracy characteristic from the analysis process executing unit, generating the engine characteristics information by associating the acquired quality characteristic and the acquired accuracy characteristic, and storing the engine characteristics information into the engine characteristics information storing unit; or updating the engine characteristics information stored in the engine characteristics information storing unit.

25. The analysis system according to claim 23, comprising an engine resources characteristics information generating unit for: causing the analysis process executing unit to, for each of the analysis engines, measure a resources characteristic representing an amount of resources used in an analysis process by the analysis engine whose operation is controlled by the analysis process executing unit, acquiring the resources characteristic from the analysis process executing unit, generating the engine resources characteristics information including the acquired resources characteristics, and storing the engine resources characteristics information into the engine characteristics information storing unit; or updating the engine resources characteristics information stored in the engine characteristics information storing unit.

26. The analysis system according to claim 23, comprising a resources allocation information storing unit for storing preset resources allocation information showing allocation of resources to the analysis engines,
wherein the input quality regulating unit is configured to set the resources amount requirement based on the resources allocation information, and determine the quality characteristic of the processing target data inputted into each of the analysis engines so as to satisfy the resources amount requirement.

27. A non-transitory computer-readable medium storing a program comprising instructions for causing an information processing device, which controls operation of an analysis system configured by combining a plurality of analysis engines executing predetermined analysis processes, respectively, to execute an analysis process, to realize:
an input quality regulating unit for determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics; and
an analysis process executing unit for inputting the processing target data of quality corresponding to the quality characteristic regulated by the input quality regulating unit into the given analysis engine, and controlling the operation of the analysis system to execute an analysis process.

28. The non-transitory computer-readable medium storing the program according to claim 27, wherein the input quality regulating unit is configured to regulate the quality characteristic of the processing target data inputted into the given analysis engine, based on the quality characteristics of the processing target data inputted into the respective analysis engines and based on a previously stored analysis process flow showing a sequence of analyses by the plurality of analysis engines, the quality characteristics being determined by the input quality regulating unit.

29. An analysis method for controlling operation of an analysis system configured by combining a plurality of analysis engines executing predetermined analysis processes, respectively, to execute an analysis process, the analysis method comprising:
determining quality characteristics of processing target data inputted into the respective analysis engines so as to satisfy a preset requirement for accuracy of an analysis result, and regulating the quality characteristic of the processing target data inputted into a given one of the analysis engines configuring the analysis system based on the determined quality characteristics; and
inputting the processing target data of quality corresponding to the regulated quality characteristic into the given analysis engine, and controlling the operation of the analysis system to execute an analysis process.

30. The analysis method according to claim 28, wherein an analysis process flow showing a sequence of analyses by the plurality of analysis engines is stored,
the analysis method comprising:
regulating the quality characteristic of the processing target data inputted into the given analysis engine, based on the quality characteristics of the processing target data inputted into the respective analysis engines and based on the analysis process flow, the quality characteristics being determined based on engine characteristics information.
